(19) United States
(12) Patent Application Publication
(10) Pub. No.: US 2006/0028675 A1
(43) Pub. Date: Feb. 9, 2006

(54) Charging system for an image processing device

(76) Inventors: Akio Watanabe, Yokohama city (JP); Hideaki Kawasaki, Yokohama city (JP); Makoto Odamaki, Miura-gun (JP); Hironobu Kurihara, Sagamihara city (JP); Yuichi Yomogida, Yokohama city (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/195,773

(22) Filed: Aug. 3, 2005

(30) Foreign Application Priority Data
Aug. 3, 2004 (JP) 2004-226746
Sep. 15, 2004 (JP) 2004-268550

(51) Int. Cl. G06F 3/12

(52) U.S. Cl. 358/1.15

(57) ABSTRACT

An image processing system including an information processing unit, an image processing unit, a transmitter, and a charging unit. The image processing unit is connected to the information processing unit and conducts image processing selected by a user to obtain image data. The transmitter transmits the image data to an external receiver via a network. The charging unit charges a fee corresponding to the image processing selected by the user before the image data is transmitted to the external receiver.

### TECHNICAL FIELD

The present disclosure generally relates to an image processing system having an information processing unit and an image processing unit and configured to conduct image processing having a plurality of functions, and an application program for operating the information processing system, and a storage medium.

### BACKGROUND

Recently, retail sores such as convenience stores have provided image processing services such as color copying by introducing digitally-controlled image forming apparatuses having multi-functions such as color copying, facsimile transmission, and a printing of digitally recorded data. Such image forming apparatus can be connected to a network system of the convenience stores to provide multi-media contents to a user.

Some background art has proposed systems to cope with such market environment.

Generally, the above-mentioned services in the convenience stores are conducted by charging a fee to a user. When the image forming apparatus only conducts a conventional copying service such as “color/monochrome selection,” “paper size”, and “number of papers,” a service fee can be calculated just by accumulating each fee for each selected function conducted for a copying service.

However, if the image forming apparatus conducts multi-functional services simultaneously, the above-mentioned conventional fee calculation has some drawbacks.

In one case, if a user uses a scanner service without using a printing service, fees for “toner” and “paper” should be excluded from a fee calculation because the “toner” and “paper” are not actually used.

In another case, if a user uses a printing and facsimile services at the same time, a fee for image scanning operation should be charged only one time because the printing and facsimile services can be conducted with the one-time image scanning operation.

In another case, an owner of convenience store may want to set a special discount fee for services conducted by an image forming apparatus so that the owner can differentiate service fees compared to other neighboring convenience stores.

The background art has proposed a charging system for such demands. For example, a multi-functional image forming apparatus is connected to an external information processing unit used for charging, and the external information processing unit is connected to a charging unit so that a complex charging process can be conducted.

However, such background art can conduct charging processes set in the information processing unit in advance, such background art has a difficulty changing a fee-setting for charging processes, thereby an image forming apparatus using such background art has constrains on fee-setting. In another words, a conventional charging process in the image forming apparatus has little flexibility to set a fee for desired services.

In addition to such drawbacks, some functions of a multi-functional image forming apparatus may not be available to an ordinary user. For example, some image forming apparatus can conduct a printing service using an image stored in a memory card or a cellular phone, for example, and also conduct an optical character reading.

Further, in the case of optical character reading, an OCR (optical character reader) reads a document image using a scanner, then extracts and recognizes characters from the image, and converts the characters to character-code sequence. Conventionally, such operation for the OCR can be conducted by connecting a scanner and a computer, in which the scanner is used for image scanning process, and the computer is used to control character recognition, data correction, and storage processes.

Such conventional image forming apparatus can also conduct a scanning process. However, an external computer such as personal computer should be connected to the image forming apparatus to retrieve the scanned image data. When considering a limited space of convenience store, such connection is not practicable in the convenience store. Therefore, convenience stores cannot provide a scanning service to a user with the conventional image forming apparatus. Accordingly, such convenience stores cannot charge a fee to a user for scanner service.

In such a background, a user may use a personal scanner in his home to scan and store images. However, such personal scanner may not have a higher functionality compared to an image scanner used in an office environment. Therefore, such user may obtain only a lower image quality and lower scanning speed, for example.

Furthermore, a user is required to purchase application software for an OCR process and PDF (Adobe Portable Document Format) formatting of scanned image, which leads to a cost-burden on a user. (Adobe Portable Document Format is a registered trademark of Adobe Systems Incorporated.)

Therefore, an ordinary user encounters difficulty in accessing an office-type image processing apparatus having a higher functionality and application software for an OCR process and PDF (Adobe Portable Document Format) formatting of scanned image.

Accordingly, a general user is hard to obtain image data having a higher quality, which can be obtained if an image processing apparatus having a higher functionality can be used.

### SUMMARY

In an exemplary embodiment, an image processing system, which includes an information processing unit, an image processing unit, a transmitter, and a charging unit is connected to a communication network. The image processing unit is connected to the information processing unit and conducts image processing selected by a user to obtain image data. The transmitter transmits the image data to an external receiver. The charging unit, connected to and controlled by the information processing unit, charges a fee corresponding to the image processing selected by the user before the image data is transmitted to the external receiver. It is to be understood that both the foregoing general description of the invention and the following detailed description are exemplary, but are not restrictive of the invention.

### BRIEF DESCRIPTION OF THE DRAWINGS

A more complete appreciation of the disclosure and many of the attendant advantages and features thereof can readily be obtained and understood from the following detailed description with reference to the accompanying drawings, wherein:

FIG. 1 is a perspective view of a multi-function image forming system according to one embodiment of the present invention;

FIG. 2 is a schematic view of a network to which a multi-function image forming system is connected;

FIG. 3 is a schematic internal configuration of a multi-function image forming system;

FIGS. 4A to 4C show a schematic internal configuration of a coin vendor;

FIG. 5 is a flow chart explaining processes conducted in a coin vendor;

FIG. 6 is a flow chart explaining a charging process conducted with a program;

FIG. 7 is a schematic view of a main menu screen;

FIG. 8 is a schematic view of a menu screen when a scanner service is selected;

FIG. 9 is a schematic view of a menu screen for selecting a storage medium for scanned image data;

FIG. 10 is a schematic view of a menu screen when a compact flash is selected as storage medium;

FIG. 11 is a schematic view of a menu screen displaying a calculated total fee;

FIG. 12 is a flow chart for a sub-routine for Step S29 in FIG. 6;

FIG. 13 is a flow chart explaining a scanning process conducted by an image forming system;

FIG. 14 is a main menu screen displayed on an operation panel;

FIG. 15 is a menu screen on an operation panel for selecting a storage medium;

FIG. 16 is a menu screen on an operation panel for indicating a setting of a storage medium to an image forming system;

FIG. 17 is a menu screen on an operation panel for indicating an exchange of a storage medium;

FIG. 18 is a menu screen on an operation panel for selecting a non-optical memory type;

FIG. 19 is a menu screen on an operation panel for selecting an optical medium type;

FIG. 20 is a menu screen on an operation panel for selecting a color or monochrome image;

FIG. 21 is a menu screen on an operation panel for selecting a resolution level of an image;

FIG. 22 is a menu screen on an operation panel for selecting a data format for an image;

FIG. 23 is a menu screen on an operation panel for selecting an OCR process;

FIG. 24 is a menu screen on an operation panel for selecting a pre-scanning of image;

FIG. 25 is a menu screen on an operation panel for designating an area for scanning;

FIG. 26 is a menu screen on an operation panel in which an area is designated for scanning;

FIG. 27 is a menu screen on an operation panel for executing a scanning for an image;

FIG. 28 is a menu screen on an operation panel for indicating a remaining storage capacity of a storage medium;

FIG. 29 is a menu screen on an operation panel for indicating a total fee for scanning and confirming a storage of scanned image data to a storage medium;

FIG. 30 is a menu screen on an operation panel for indicating that a writing process of scanned image data to a storage medium is in session;

FIG. 31 is a menu screen on an operation panel for indicating that a scanner service has completed;

FIG. 32 is a menu screen on an operation panel for indicating that e-mail transmission is available in addition to storing to a storage medium; and

FIG. 33 is a menu screen on an operation panel for inputting e-mail address.

### DETAILED DESCRIPTION OF EXAMPLE EMBODIMENTS

In describing example embodiments illustrated in the drawings, specific terminology is employed for the sake of clarity. However, the disclosure of this present invention is not intended to be limited to the specific terminology so selected and it is to be understood that each specific element includes all technical equivalents that operate in a similar manner.

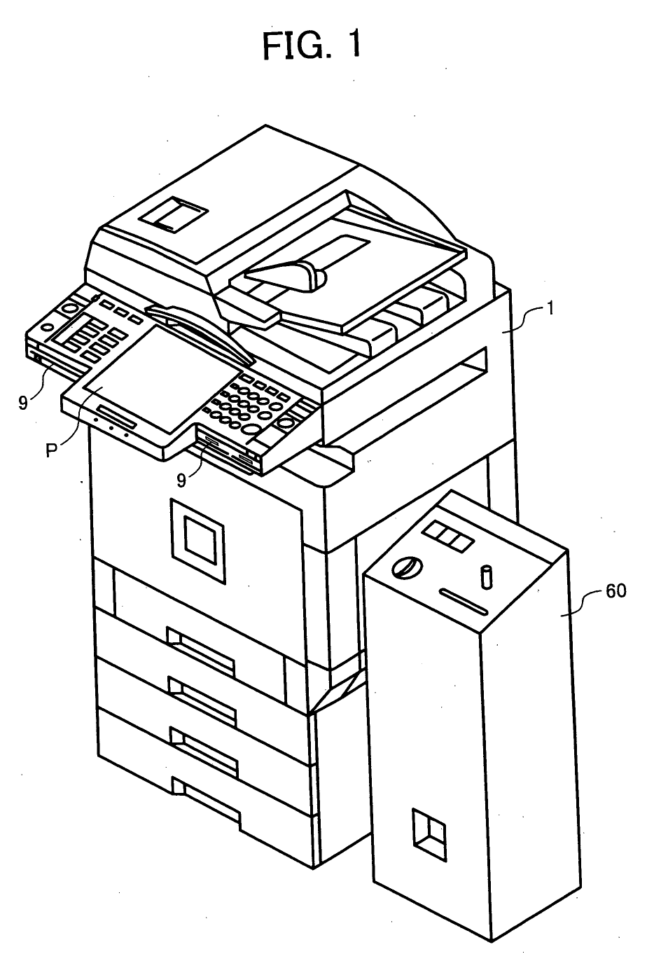

Referring now to the drawings, wherein like reference numerals designate identical or corresponding parts throughout the several views, and more particularly to FIG. 1 thereof, an image forming system according to and exemplary embodiment is described.

FIG. 1 is a perspective view of a multi-function image forming apparatus 1 and a coin vendor 60 connected to the image forming apparatus 1 according to an exemplary embodiment of the present invention. The image forming apparatus 1 and the coin vendor 60 can be provided, for example, in a convenience store which a user can selectively use functions of the image forming apparatus 1 by paying a fee corresponding to such selected functions. The image forming apparatus 1 conducts an image processing and the coin vendor 60 functions as a charging unit.

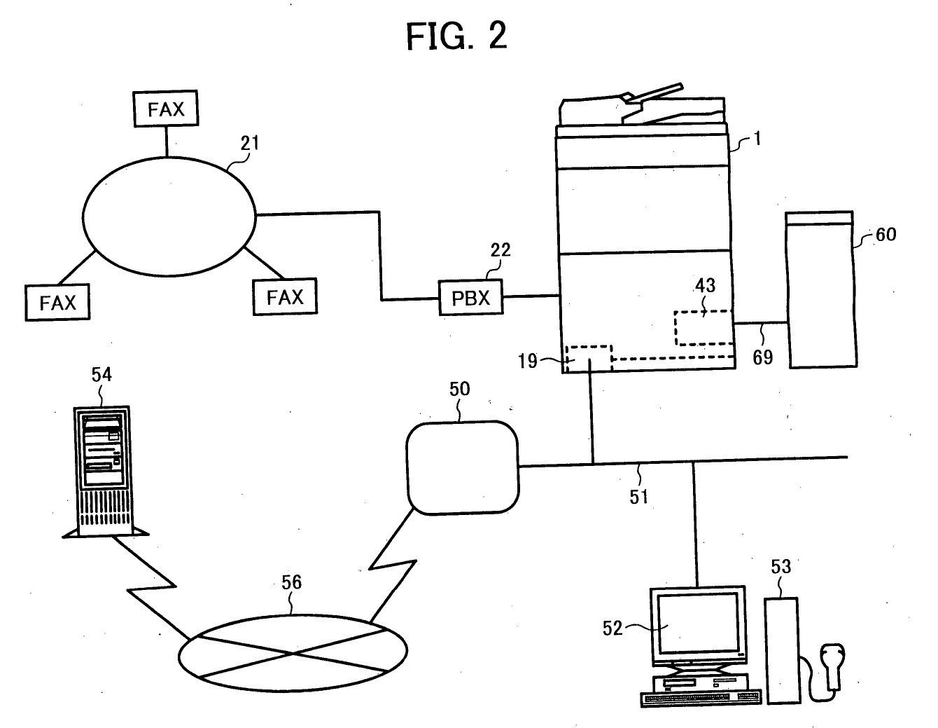

As shown in FIG. 2, the coin vendor 60 is connected to an interface 43 of the image forming apparatus 1 via a serial signal line 69. The image forming apparatus 1 is connected to a LAN (local area network) 51 in a store via a hub 19, and the LAN 51 can be connected to the Internet 56 via an ADSL (asymmetric digital subscriber line) modem 50. Accordingly, the image forming apparatus 1 can communicate with other terminals such as a server 54. Further, a computer terminal 52 and a bar-code unit 53 can be connected to the LAN 51.

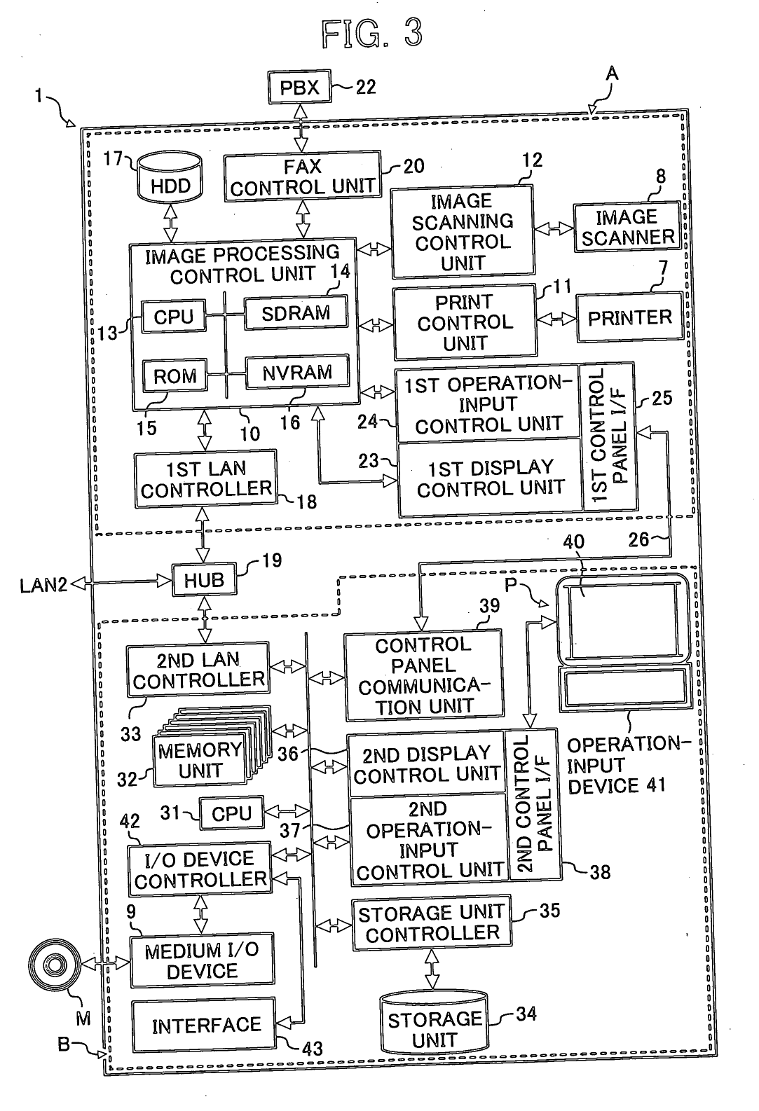

FIG. 3 shows an internal configuration of the image forming apparatus 1. Although the image forming apparatus 1 is described below, configurations and functions of the image forming apparatus 1 are incorporated by reference to the U.S. patent application Publication No. US 2005/0012953 (Filed Jan. 20, 2005).

As shown in FIG. 3, the image forming apparatus 1 includes an image processing section A and an information processing section B. The image processing section A mainly conducts image processing operations, and the information processing section B mainly conducts operations to control the image forming apparatus 1.

As shown in FIG. 3, the image processing section A includes a printer 7, an image scanner 8, an image processing control unit 10, a print control unit 11, an image scanning control unit 12, a HDD (hard disk drive) 17, a first LAN controller 18, a FAX control unit 20, a first display control unit 23, a first operation-input control unit 24, and a first control panel I/F (interface) 25.

As also shown in FIG. 3, the information processing section B includes an operation panel P, a medium F/O device 9, a CPU (central processing unit) 31, a memory unit 32, a second LAN controller 33, a storage unit 34, a storage unit controller 35, a second display control unit 36, a second operation-input control unit 37, a second control panel I/F 38, a control panel communication unit 39, an I/O device controller 42, and an interface 43.

The image processing section A is described below.

The image processing control unit 10 controls image processing operations in the image processing section A. The image processing control unit 10 is connected to the print control unit 11 which controls the printer 7, and the image scanning control unit 12 which controls the image scanner 8.

The print control unit 11 instructs a print command to the printer 7 in response to a command from the image processing control unit 10, and the printer 7 outputs (i.e., prints) an image on a recording medium such as, for example, a transfer sheet. The printer 7 is able to conduct full color printing by a plurality of methods such as electro-photography, ink jet method, dye-sublimation method, silver salt photography, direct thermal printing, thermal wax transfer method, for example.

The image scanning control unit 12 drives the image scanner 8 in response to a command from the image processing control unit 10.

The image scanner 8 can scan a document image by illuminating a light to a document face, and the light reflected on the document face is guided and focused on a light receiving element (not shown) such as CCD (charge coupled device) via a mirror and lens (not shown). Then, the focused light is processed by an analog-to-digital conversion process to generate 8-bit digital image data for red, green, blue (RGB).

As shown in FIG. 3, the image processing control unit 10 includes a CPU (central processing unit) 13 as a main processor, a SDRAM (synchronous dynamic random access memory) 14, a ROM (read only memory) 15, and a NVRAM (non-volatile random access memory) 16, which are interconnected each other by a bus.

The SDRAM 14 stores the image data scanned by the image scanner 8 temporarily and transmits such image data to the printer 7 when a print command is executed. The ROM 15 stores a control program or the like. The NVRAM 16 stores data even if a power of the image forming apparatus 1 is tuned “off” and stores system information such as system log, system settings, and log information.

The image processing control unit 10 is also connected to the HDD 17, the first LAN controller 18, and the FAX control unit 20.

The HDD 17 stores a large number of image data and job histories.

The first LAN controller 18 is connected to the hub 19 in the image forming apparatus 1 so that the image processing section A can be connected to the LAN 2.

The FAX control unit 20 controls facsimile transmission. The FAX control unit 20 is connected to a PBX (private branch exchange) 22 and a public telephone network 21 so that the image forming apparatus 1 can communicate a facsimile transmission with remotely located facsimile devices via the public telephone network. The public telephone network 21 may includes an ISDN (integrated services digital network), for example.

The image processing control unit 10 is also connected to the first display control unit 23 and the first operation-input control unit 24.

The first display control unit 23 and the first operation-input control unit 24 are connected to a communication cable 26 via the first control panel I/F 25.

In response to a control command from the image processing control unit 10, the first display control unit 23 outputs an image-display control signal to the information processing section B via the first control panel I/F 25 and the communication cable 26, and controls an image display at the operation panel P in the information processing section B.

When an operator conducts a functional setting and an input operation from the operation panel P in the input information processing section B, an input control signal is generated. The first operation-input control unit 24 receives such input control signal via the communication cable 26 and the first control panel I/F 25 under the control of the image processing control unit 10. In other words, the image processing section A can be directly monitored and controlled from the operation panel P in the information processing section B via the communication cable 26.

Compared to a conventional image forming apparatus which independently conducts image forming operations therein, the image forming apparatus 1 including the image processing section A and the information processing section B conducts image forming operations by communicating information between the image processing section A and the information processing section B.

In an exemplary embodiment, image processing section A is connected to the information processing section B via the communication cable 26 so that the operation panel P in the information processing section B can be used for conducting operations in the image forming apparatus 1. In other words, the first display control unit 23 and the first operation-input control unit 24 in the image processing section A are coupled to the operation panel P.

With the above-described configuration for an image processing system, the image processing section A can receive print data having image information and a print command from an external unit (e.g., server, client computer, and facsimile). Then the image processing section A analyzes the print data and convert the print data to an appropriate data format such as bit map to output as image, and determines a print mode in response to the print command. The image processing section A can receive such print data and command via the first LAN controller 18 or the FAX control unit 20, for example.

The image processing section A can transmit data stored in the SDRAM 14 or HDD 17 to the external unit (e.g., server computer, client computer, facsimile). Such data includes print data, scanned document data, output image data generated from the print data or scanned document data, and compressed data prepared by compressing the print data, scanned document data, and output image data.

In the image processing section A, scanned image data is transmitted from the image scanner 8 to the image processing control unit 10.

Then the image data receives a correction process to compensate signal degradations due to an optical system configuration and quantization process which converts analog signals to digital signals, and is written on the SDRAM 14. The image data stored in the SDRAM 14 is then converted to an output image data in the print control unit 11, and transmitted to the printer 7.

Hereinafter, the information processing section B having the operation panel P is described.

The information processing section B includes a configuration having a microcomputer controlled by a general purpose OS (operating system) which can be used for an information processing apparatus such as personal computer, for example. The information processing section B also includes the CPU 31 functioning as a main processor, which is connected to the memory unit 32 and the storage unit controller 35 via a bus.

The memory unit 32 includes a RAM used for a working area of the CPU 31 and a ROM used for storing activation program. The storage unit controller 35 controls data input/output to the storage unit 34 such as HDD which stores an OS (operating system) and an application program.

The CPU 31 is also connected to the second LAN controller 33, which couples the information processing section B to the LAN 2 via the hub 19.

As for an IP (internet protocol) address (i.e., network address), a first IP address is assigned to the first LAN controller 18 in the image processing section A, and a second IP address is assigned to the second LAN controller 33, in which the first and second IP addresses are different. Accordingly, the image forming apparatus 1 of an example embodiment includes two IP addresses. Accordingly, the image processing section A and the information processing section B are connected to the LAN 2, and are capable of exchanging data in such configuration. As shown in FIG. 3, the image forming apparatus 1 is connected to the LAN 2 via the hub 19, by a single interface.

The CPU 31 is also connected to the second display control unit 36 and the second operation-input control unit 37 which controls the operation panel P. The operation panel P includes a display unit 40 and an operation-input device 41, in which the display unit 40 includes an LCD (liquid crystal display), for example. An operator can select or input functional settings by touching the LCD, for example. The second display control unit 36 transmits an image-display control signal to the display unit 40 via the second control panel I/F 38, and the display unit 40 displays predetermined information corresponding to the received image-display control signal.

When an operator conducts a functional setting and an input operation from the operation-input device 41, an input control signal is generated. Then, the second operation-input control unit 37 receives such input control signal via the second control panel I/F 38.

The CPU 31 is also connected to the control panel communication unit 39 which is connected to the first control panel I/F 25 in the image processing section A via the communication cable 26. The control panel communication unit 39 receives an image-display control signal from the image processing section A.

In addition, the control panel communication unit 39 transmits an input control signal (e.g., functional setting and input operation) set by an operator at the operation panel P to the image processing section A.

Although a detailed explanation is provided below, the image-display control signal transmitted from the image processing section A and received by the control panel communication unit 39 is converted to data which can be used at the display unit 40 of the operation panel P, and then transmitted to the second display control unit 36. In a similar manner, an input control signal (e.g., functional setting and input operation) set by an operator at the operation panel P is converted to data which can used in the image processing section A, and then transmitted to the control panel communication unit 39.

As mentioned above, the storage unit 34 stores an OS (operating system) and application programs to be executed by the CPU 31. Therefore, the storage unit 34 functions as a storage medium which stores the application programs.

As for the image processing system of an exemplary embodiment, when a user turns on the power of the image forming apparatus 1, the CPU 31 activates an activation program stored in the memory unit 32, writes the OS (operating system) stored in the storage unit 34 to the RAM in the memory unit 32, and activates the OS (operating system).

The OS (operating system) conducts a plurality of operations such as activating a program, reading and storing information in response to a user's operation. Such OS (operating system) may include a general propose OS such as “Windows” (registered trademark) which is also used in an external unit (e.g., server computer and client computer), for example. In such configuration, a program run by the OS (operating system) is referred as “application program,” in general.

The information processing section B also includes the medium 1/O device 9 that writes or reads information on a storage medium M. The storage medium M can store an OS (operating system), program codes (i.e., control program) for a device driver and an application program, and image data or the like. The storage medium M may include, for example a flexible disk, hard disk, optical disk (e.g., CD-ROM, CD-R, CD-RW, DVD-ROM, DVD-RAM, DVD−R, DVD+R, DVD−RW, DVD+RW), magnet-optical disk (MO disk), and a semiconductor medium.

The medium I/O device 9 may include at least one of a flexible disk drive unit, optical disk drive unit, MO(magnet-optical) drive unit, medium drive unit, which writes and reads information such as program code and image data to the storage medium M. The medium I/O device 9 is controlled by the I/O device controller 42 which is connected to the CPU 31 via the bus as shown in FIG. 3. As shown in FIG. 1, a user can insert the storage medium M in a slot provided for the medium I/O device 9, for example.

The slot can be formed in a shape which corresponds to the shape of the storage medium M, and slots having different shapes can be provided in the image forming apparatus 1 so that a plurality of types of storage medium M can be used.

Although the storage unit 34 stores the application program as above-mentioned, the storage medium M can also store the application program which is to be installed in the image forming apparatus 1. Therefore, the storage medium M can also function as storage medium for application programs.

Furthermore, application programs can be downloaded from an external unit via the Internet 56 and the LAN 2, and can be installed to the storage unit 34, for example.

The I/O device controller 42 is connected to the interface 43 which can use a plurality of types such as USB (universal serial bus), IEEE (Institute of Electrical and Electronics Engineers) 1394, and SCSI (small computer system interface) or the like. Accordingly, a variety of devices (e.g., digital camera) can be connected to the image forming apparatus 1 via the interface 43.

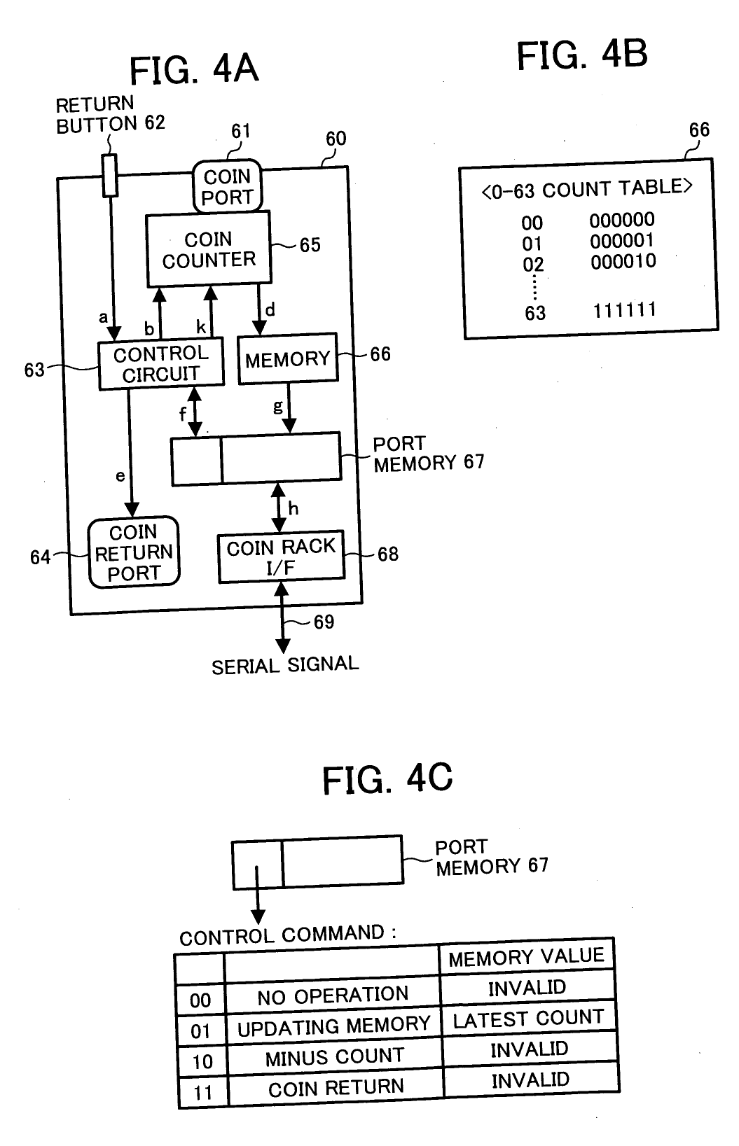

Hereinafter, processes in the coin vendor 60 are explained, with specific reference to FIGS. 4A-4C.

As shown in FIG. 4A, the coin vendor 60 includes a coin port 61, a return button 62, a control circuit 63, a coin return port 64, a coin counter 65, a memory 66, a port memory 67, a coin vendor I/F 68, and a serial signal line 69.

A user can insert a coin from the coin port 61. If the coin vendor 60 has un-used coins therein after completing a service such as copying, the user can push the return button 62 to retrieve coins from the coin return port 64. The control circuit 63 controls operations in the coin vendor 60.

The coin counter 65 recognizes a type of coins inserted from the coin port 61 and counts a money amount of the inserted coin. The memory 66 retains the money amount counted by the coin counter 65, and the port memory 67 temporarily retains information to be communicated with a host side (i.e., image forming apparatus 1).

The coin vendor I/F 68, functioning as an interface, is connected to the host side (i.e., image forming apparatus 1), and can convert a serial signal to a parallel signal and vice versa. The serial signal line 69 connects the coin vendor 60 and the host side (i.e., image forming apparatus 1) to communicate information interactively.

FIG. 4B is a schematic view explaining memorization of numeric value in the memory 66, and FIG. 4C is a schematic view explaining the port memory 67.

Hereinafter, an operation sequence in the coin vendor 60 will be described.

When a coin is inserted in the coin port 61, the coin counter 65 converts money amount of the inserted coin to numerical points in response to types of coins, for example. Japanese “10 yen” coin can be counted as “1 point.” If so, coins worth of 230 yen can be counted as “23 points”, for example, and the coin counter 65 retains such points. Although the Japanese “yen” is used as a unit of money to be inserted to the coin port 61 in an example embodiment, any currency including dollar can be used in an example embodiment. In addition to the coin port 61, the coin vendor 60 can further include a bill port (not shown) to be inserted with a money bill.

A number of points increases when a coin is inserted one by one, however, the coin counter 65 is designed not to hold more than a predetermined maximum point. For example, in case of a count table shown in FIG. 4B, the predetermined maximum number of points is 63. Therefore, when a number of points inserted in the coin vendor 60 exceeds 63-points, coins equivalent to an excess points are returned to the return port 64 further, when a user pushes the return button 62, the control circuit 63 senses a return button signal “a,” and activates a coin return signal “e.” When the coin return signal “e” is active, un-used coins are returned to the return port 64.

The control circuit 63 can execute an operation by transmitting a control command to an upper 2-bit of the port memory 67.

Specifically, operations are controlled with a 2-bit information of “00 to 11” as shown in FIG. 4C. Each 2-bit is defined as below, for example.

“00” (no operation): no operation is activated, and the value of the memory 66 is invalid.

“01” (updating memory value): a memory updating signal “k” is activated. In response to the memory updating signal “k,” the coin counter 65 retaining a latest number writes the latest number to the memory 66 with a memory read/write signal “d.”

“10” (minus count): a minus counting signal “b” is activated. In response to the minus counting signal “b,” the coin counter 65 retaining a latest number adds a minus count to the latest number.

“11” (coin return): a return signal “e” is activated.

In an exemplary embodiment, the port memory 67 includes 8 bits, for example. The upper 2-bit is used for control command which is transmitted as signal “f”, and the lower 6-bit retains information transmitted from the memory 66 as signal “g”. The memory 66 is used as the count table as shown in FIG. 4B.

The coin vendor I/F 68 is connected to the port memory 67 with a port data signal line “h” having a width of 8-bit. The coin vendor I/F 68 and a host side (i.e., image forming apparatus 1) are connected each other by the serial signal line 69. Therefore, the coin vendor I/F 68 conducts a signal conversion such as serial-to-parallel or parallel-to-serial signal conversion.

The coin vendor 60 can be operated by simple commands which instruct input and output operations. However, if a routine program for such input-and-output operation is integrally embedded in an application program, a improvement or correction work of application program may become complex and time-consuming.

Accordingly, the coin vendor 60 can be operated by a program prepared as a coin vendor module program (i.e., charging unit control program) or as a module component of an application program to improve a developing efficiency of the application program. The image forming apparatus 1 can use this charging unit control program to calculate a fee for service conducted in the image forming apparatus 1, and the coin vendor module program can conduct a charging in the coin vendor 60. Such charging unit control program can be stored in the storage medium M, and installed in the storage unit 34 so that the CPU 31 can run the application program.

The application program and the coin vendor module program have two functions, that is, a “balance check” and “charging instruction.”

As for the “balance check,” an argument (binary) N is set to “00” and an argument M is set to “FF”. When the coin vendor module program sets “balance point” to the argument M, “charging instruction” sets “charging point value” to the argument N, and “FF” to the argument M. When the application program is used to return coins to a user, the argument (binary) N is set to “FF.”

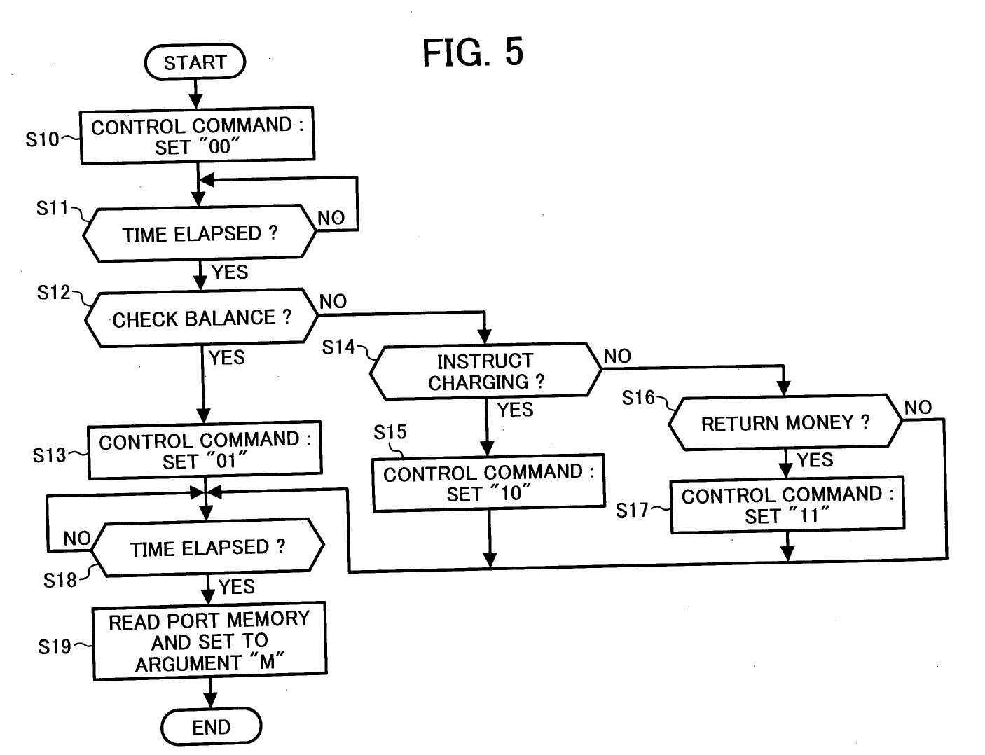

FIG. 5 shows a flow chart explaining operations of the coin vendor module program, which conducts Steps S10 to S19.

In Step S10, when the application program calls the coin vendor module program, a control command is set to “00,” which means “no operation.” Specifically, a binary number of “00” is written in an upper 2-bit of the port memory 67, and the port memory 67 is connected to the image forming apparatus 1 via the coin vendor I/F 68 and the serial signal line 69. The coin vendor 60 and the image forming apparatus 1 can be connected each other by connecting the interface 43 and the coin vendor I/F 68 using a variety of type of interfaces such as USB, RS-232C, and SCSI.

As for the coin vendor I/F 68, a driver software should be recognized by an OS (operating system). Such recognition process is known; therefore an explanation for this matter is omitted.

In Step S11, the CPU conducts a waiting for a predetermined time by suspending processing operation. The predetermined time is allocated so that the port memory 67 in the coin vendor 60 can be re-written. Any methods such as interruption method can be used for detecting a completion of the processing in the coin vendor 60, although such methods may require a complex hardware.

In Steps S12 to S17, the CPU judges what kind of processing is ordered by the application program, and sets a respective control command corresponding to each processing order. Then in Step S18, the CPU conducts a waiting for a predetermined time.

After the predetermined time has elapsed, the CPU reads information in the port memory 67, and edits and sets the information to the argument M in Step S19 as a latest balance point.

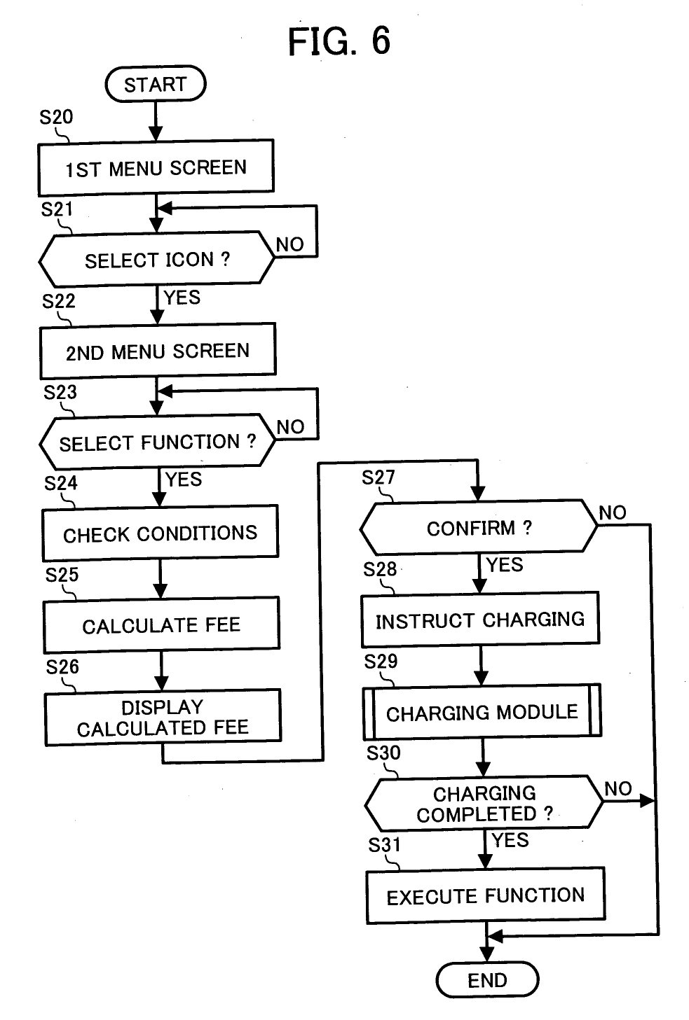

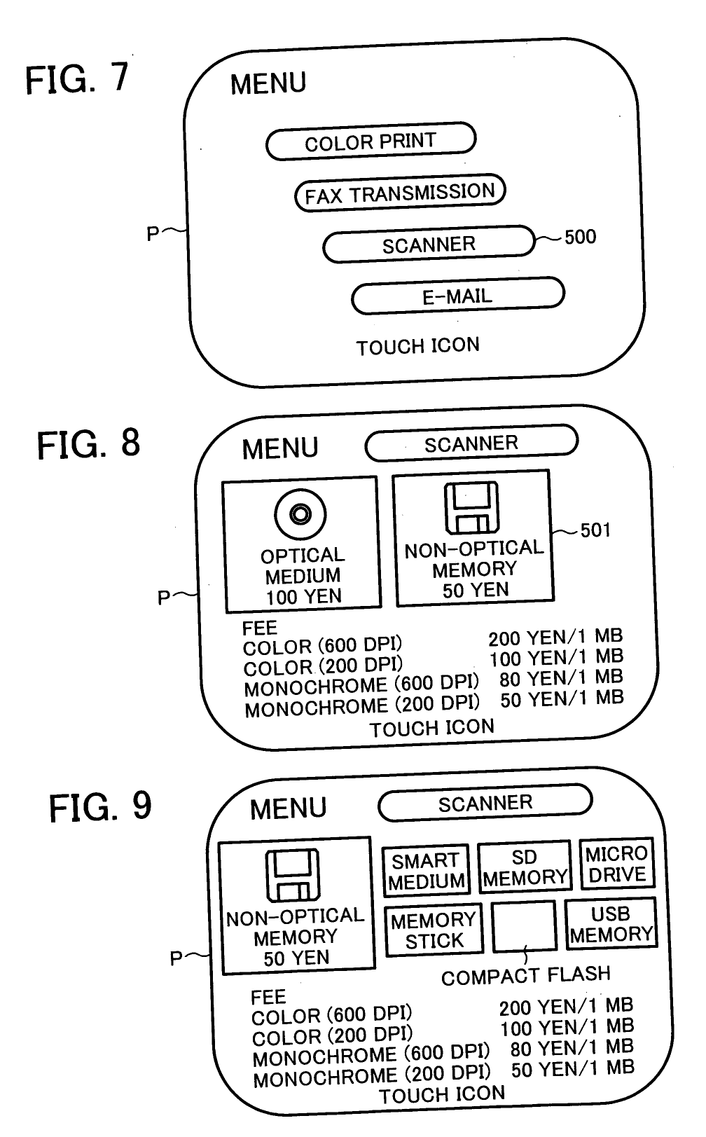

Hereinafter, a charging process conducted by the application program is explained with a flow chart in FIG. 6 and menu screens shown in FIGS. 7 to 12.

In Step S20, a first menu screen indicating types of services is displayed on the operation panel P of the image forming apparatus 1 as shown in FIG. 7. In the exemplary menu screen of FIG. 7, the types of services include “color print service,” “facsimile transmission service”, “scanner service,” and “e-mail service,” for example. The operation panel P may include a touch panel using an LCD (liquid crystal display), for example, and when a user selects an icon on the menu screen of operation panel P in Step S21, the first menu screen shifts to a second menu screen for each service in Step S22. For example, if a user selects “scanner service 500” on the first menu screen, the second menu screen shown in FIG. 8 is displayed.

In Step S23, a user can select a next function from the second menu screen shown in FIG. 8. For example, if a user selects an icon 501 on the second menu screen shown in FIG. 8, the CPU selects a process of “non-optical memory writing.” It should be noted that the configuration of the menu screen may take a different layout depending on types of services and functions to be provided.

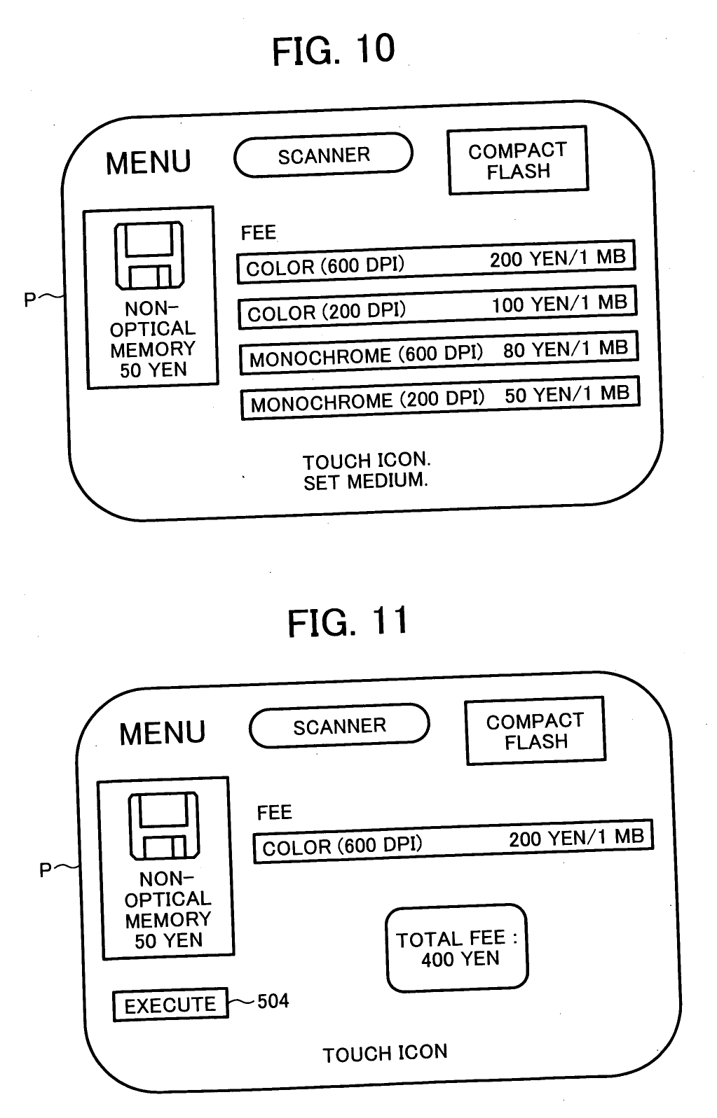

In an exemplary embodiment, if a user selects an icon 501 on the second menu screen shown in FIG. 8, additional menu screens are displayed as shown in FIGS. 9 and 10 to select functions which are related to the icon 501, for example.

On a third menu screen shown in FIG. 9, a user can select types of storage medium used for storing the image data obtained by “scanning process.” For example, when a user selects “compact flash (a registered trademark)” on the third menu screen shown in FIG. 9, a fourth menu screen is displayed as shown in FIG. 10.

Such “scanning process” can be conducted by using a configuration of the image forming apparatus 1 shown in FIG. 3. Specifically, a “scanning process” for a document image can be conducted with a collaboration of the image scanner 8, image scanning control unit 12, and image processing control unit 10.

The scanned image data is temporarily stored in the HDD 17, then transferred to the memory unit 32 in the information processing section B via the first LAN controller 18, and written in a storage medium M such as “compact flash (a registered trademark).” A writing to the storage medium M may be conducted by using the medium I/O device 9, for example. Such a process can be conducted by an application program executed on a general purpose OS (operating system) running in the information processing section B.

Similarly, services other than the “scanner service” displayed on the first menu screen shown in FIG. 7 can be provided by using an application program, which can collaborate a plurality of units in the image forming apparatus 1.

An explanation of application programs providing such services is omitted at this point because an exemplary embodiment is used to explain a charging process for services provided by the image forming apparatus 1.

When a user selects the scanner service on the first and second menu screen, in Step S24, the CPU judges whether the selected service can be conducted. For example, the CPU judges whether a document is set on the image scanner 8, whether a storage medium is inserted in the medium I/O device 9, or whether a mechanical malfunction happens, or the like. Such condition checking process is required because a charging inquiry to a user should be canceled if a malfunction or the like happens.

In Step S25, the CPU calculates a fee for the function selected in Step S23. For example, if a user selects functions of “writing to compact flash (registered trademark)” and “scanning with COLOR (600 dpi)”, and the CPU judges a data size is 2 MB (mega byte) based on a paper size of the document, a total fee of “400 yen” is calculated and displayed on the operation panel P. In an exemplary embodiment, an application program can include such charging process, and conditions for charging can be selectively changed.

Because an application program can be easily installed in the information processing section B of the image forming apparatus 1, a conventional universal fee charging system for retail stores such as convenience stores can be changed to a independent fee charging system, in which each store can adjust conditions for charging in response to a market environment of each store.

In Step S26, the calculated total fee is displayed on the operation panel P as shown in FIG. 11. If a user agrees the calculated fee, a user touches an execution icon 504 in Step S27. If a user does not select the execution icon 504 within a predetermined time, the process goes to an END. If a user agrees the calculated fee in Step S27, the application program transfers the processing to the coin vendor module program and set conditions for charging process in Step S28.

In the example shown in FIG. 11, the total fee is 400 yen. If 10 yen is counted as one point, the total fee of 400 yen is counted as 40 points in Step S28.

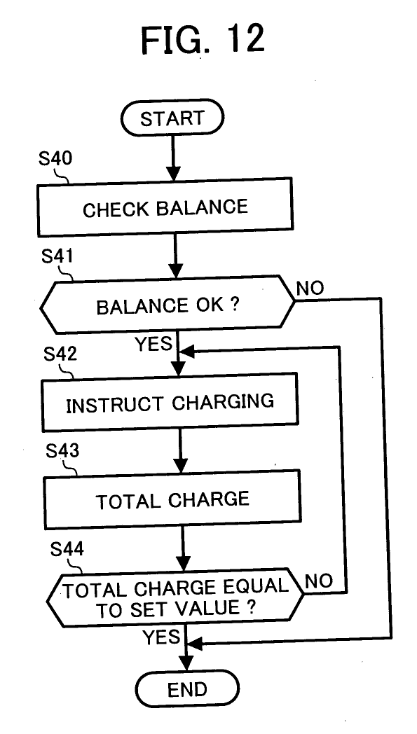

In Step S29, a charging process is conducted in the coin vendor 60. Such charging process is explained with a flow chart having steps S40 to S44 as shown in FIG. 12.

As for the above example in FIG. 11, 40 points is set to the argument, and the processing is transferred to the coin vendor module program.

As shown in FIG. 12, in Step S40, the CPU confirms a balance at first, then the above-described Steps S10 to S19 are conducted and the balance amount is checked in Step S41. If the balance amount is not sufficient, the process goes to an END. If the balance amount is sufficient, the process goes to Step S42.

In Step S42, the CPU instructs a start of charging to withdraw money from the balance amount. In an exemplary embodiment, the CPU repeats the charging instruction until the process completes for all 40 points by repeating Steps S42 to S44. When the coin vendor 60 completes the charging process normally, the process goes back to Step S30 in FIG. 6, and the CPU conducts the selected function in Step S31.

The above-mentioned charging process (e.g., instructions and functions) are just one example, thereby, without liming the combinations of instructions and functions described in an exemplary embodiment, a user can set any kind of combinations of instructions and functions to an application program. For example, the charging process in Steps S28 to S29 can be conducted after conducting the selected function. In another case, an application program can include a program code by which a charging is not conducted under a certain condition.

When a user uses simple copying functions for copying service such as color/monochrome selection, number of pages, or paper size selection, the copying service stops its operation when a money balance in the coin vendor 60 becomes zero. For example, assume that a copying service is provided under a condition of 10 yen per one copy, and a user sets a copying of 10 pages. If the money balance is 10 points or greater (i.e., 100 yen or greater), copying of 10 pages can be conducted.

Alternatively, if the money balance is 5 points (i.e., 50 yen), copying service stops its operation after copying 5 pages. If the user put another 50 yen to the coin vendor 60, copying of remaining 5 pages can be conducted. As such, if the money balance is less than a fee for selected service, such service stops its operation. In case of a simple copying service, an interruption of the service may not cause a significant problem to a user because the service can be resumed by just inserting additional money.

However, such interruption may cause drawbacks in case of facsimile service and scanner service. For example, assume a case than a user wants to send 1 pages (costing 1,000 yen, for example) by facsimile service but the money balance in the coin vendor 60 is 500 yen. If a service interruption is conducted as in the copying service, facsimile transmission is interrupted even though a 10-page facsimile transmission has not completed. If such interruption happens during the facsimile transmission, the user may experience an inconvenience of incomplete facsimile transmission.

Therefore, in an exemplary embodiment of the present invention, money balance is checked before conducting a service such as facsimile transmission and writing of scanned image data to a storage medium. If the money balance is enough for a service selected by a user, such service is conducted. However, if the money balance is not enough for a service selected by a user, the user is instructed to insert additional money to conduct the service, and the service is conducted after confirming the money balance is enough for the service. The above-described situations can be similarly applied to a scanner service.

With such configuration, facsimile service and scanner service can be conducted without interruption, thereby a user can use such services without worrying the money balance during the services.

In the above-described example embodiment, the coin vendor 60 is employed as a charging unit, for example. However, as long as the process explained with the flow chart having Steps S20 to S31 in FIG. 6 can be secured, the image forming apparatus 1 can be used with a variety of charging units to charge a fee to a user. For example, a charging unit using credit card, debit card, electronic money, prepaid card and FeliCa card system can be used to charge a fee to a user, wherein FeliCa is a registered trademark of Sony Corporation, and the FeliCa card system uses a non-contact IC (integrated circuit) card technology.

However, if such variety of charging units are used, a part of the application program which instructs Steps S28 and S29, and Steps S40 to S44 which is conducted in response to Steps S28 and S29, and the coin vendor module program which conducts a process of Steps S10 to S19 in the coin vendor 60 may require changes to be compatible with such variety of charging units.

Furthermore, the image forming apparatus 1 can be equipped with a plurality of charging units including different types of charging units.

Furthermore, an administrator of the image forming apparatus (e.g., owner of convenience store) can easily change a fee-setting with an aid of fee table (not shown) and a terminal computer to input new information, and can set a new fee system to the image forming apparatus. The administrator may select discretional fee for each service and starting date of new fee system, for example. Such setting can be automatically uploaded to the image forming apparatus by a network, for example.

With a configuration of the above-described example embodiment, a flexible charging system, which is difficult for a conventional image forming system, can be achieved.

In the above-described exemplary embodiment, the image processing section A of the image forming apparatus 1 is used as a multi-functional machine. Although the image processing section A of the image forming apparatus 1 in the above-described example embodiment includes functions shown in FIG. 3, the image processing section A can further includes other types of functions relating to image processing such as printing, facsimile and scanning.

Hereinafter, a scanning process that can be conducted with image forming apparatus 1 having multiple-functions is explained as one favorable service to be provided to a user. Specifically, a scanning process and its related functions such as storage medium selection and fee calculation to be conducted in the image forming apparatus 1 is described.

As mentioned above, in the information processing section B, an application program stored in the storage medium M can be read by the medium I/O device 9, and can be installed in the storage unit 34.

A scanning process explained as below is conducted with the CPU 31 and the application program installed in the storage unit 34.

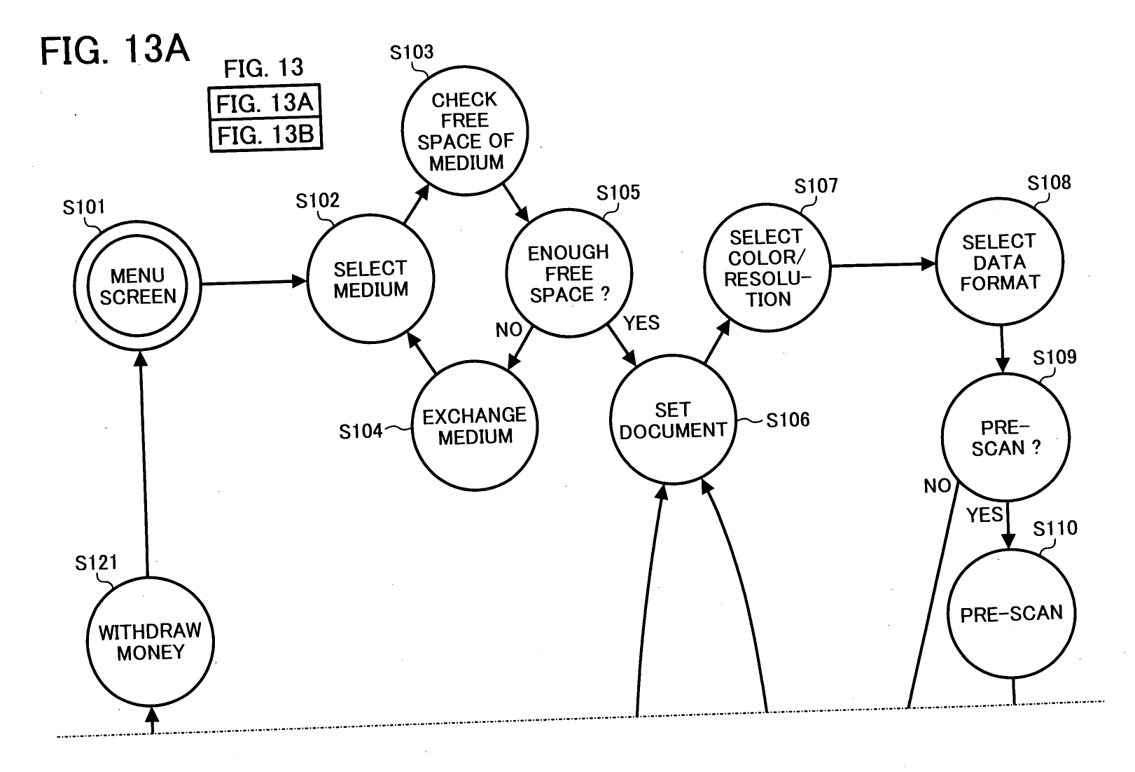

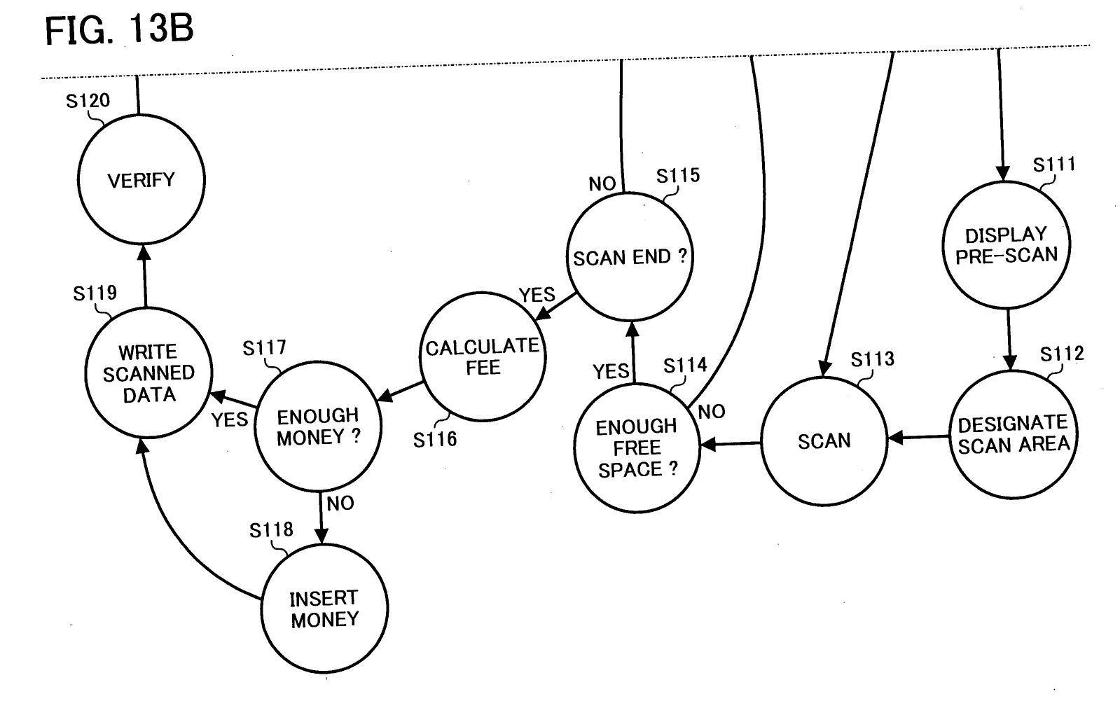

FIG. 13 is a flow chart explaining a scanning process conducted with the CPU 31 and the application program.

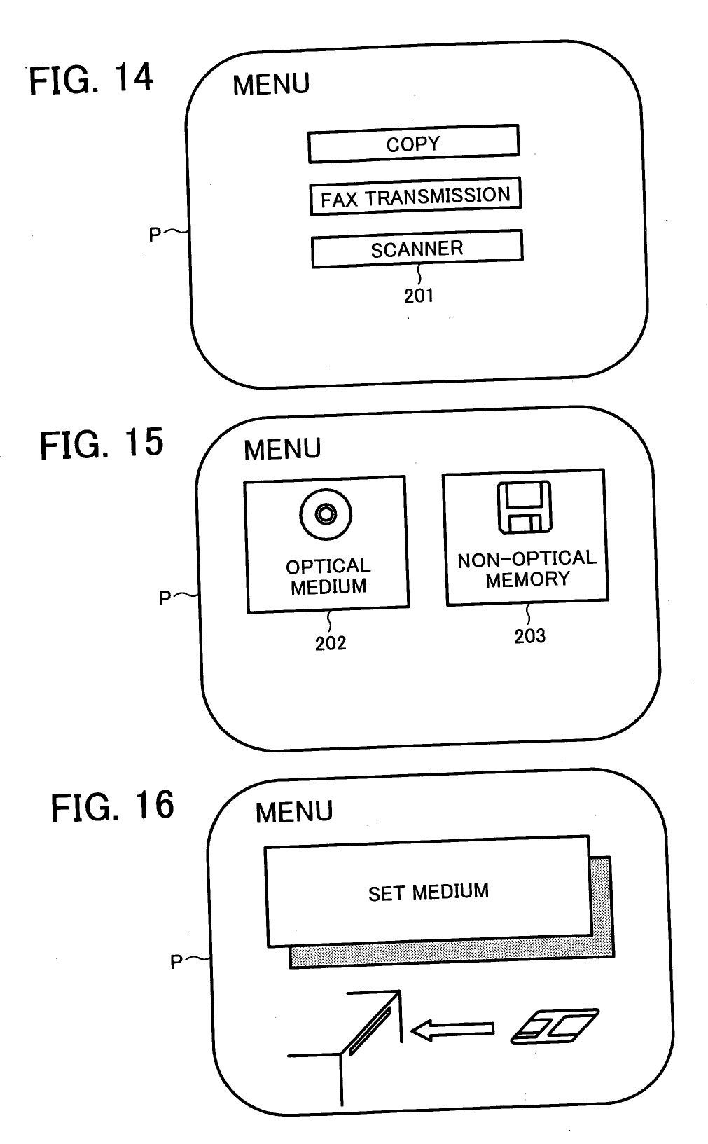

In Step S101, a first menu screen shown in FIG. 14 is displayed on the operation panel P. When a user selects a “scanner 201” displayed on the operation panel P, a second menu screen shown in FIG. 15 is displayed on the operation panel P in Step S102.

When a user selects an optical medium 202 or non-optical memory 203 as a storage medium M to be written with image data, the operation panel P displays a third menu screen shown in FIG. 16 indicating an insertion of the storage medium M, and the CPU 31 recognizes the selected storage medium M, and determines free space on the storage medium M in Step S103.

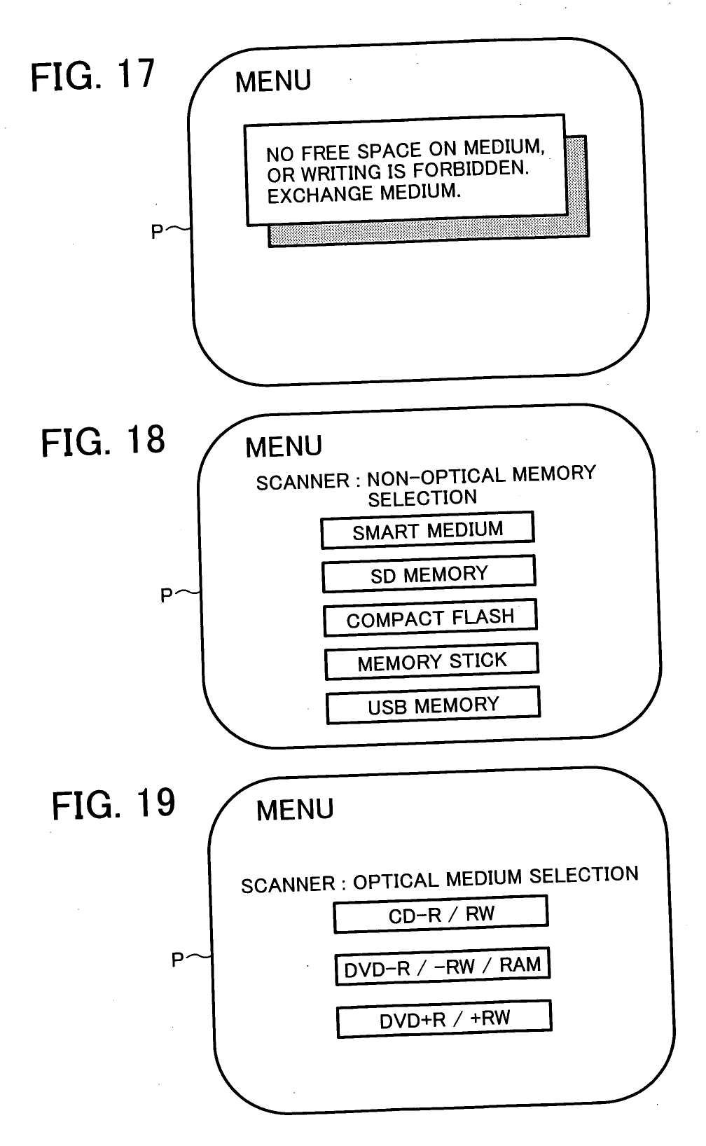

In Step S105, the CPU 31 judges whether the free space of the storage medium M is sufficient to write the image data thereon. If the CPU 31 judges that the free space of the storage medium M is sufficient to write the image data thereon, the process goes to Step S106. However, if the CPU 31 judges that the free space of the medium is not sufficient to write image data thereon, the process goes to Step S104, and a fourth menu screen shown in FIG. 17 is displayed on the operation panel P to inform a user to exchange the storage medium M, and the process goes back to Step S102.

If a user selects the optical medium 202 or non-optical memory 203 in the second menu screen shown in FIG. 15, a user can further select types of the storage medium M in detail on a fifth or sixth menu screen shown in FIG. 18 and FIG. 19, respectively, and inserts the selected type of the storage medium M. In another case, the image forming apparatus 1 can take a configuration that recognize a type of storage medium M automatically when a user inserts a storage medium to the medium I/O device 9 of the image forming apparatus 1.

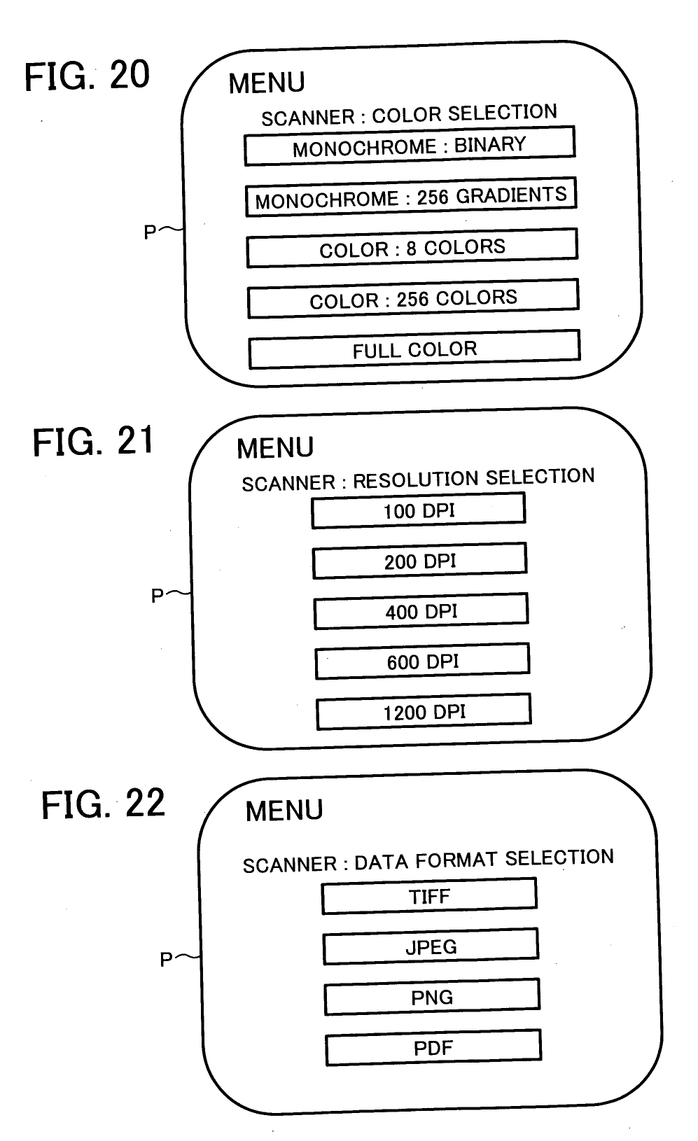

In Step S106, a sensor (not shown) provided to the image scanner 8 senses a placement of document on a scanning face (not shown) of the image scanner 8, and then the CPU 31 instructs the operation panel P to display a seventh menu screen shown in FIG. 20 so that a user can select a scanning mode. Such scanning mode includes a selection of color or monochrome mode and a gradient level of the scanned image having color or monochrome, for example, as shown in FIG. 20.

In Step S107, a user can also select an image resolution level from an eighth menu screen shown in FIG. 21, and then in Step S108, a user can select a data format from a ninth menu screen shown in FIG. 22 for the image data to be scanned by the image scanner 8. Such data format includes TIFF (Tagged Image Data format), JPEG (Joint Photographic Experts Group), png (Portable network Graphics), PDF (portable document format file) or the like. Although not shown, the image forming apparatus 1 can provide a menu screen from which a user can select compression rate of the scanned image data.

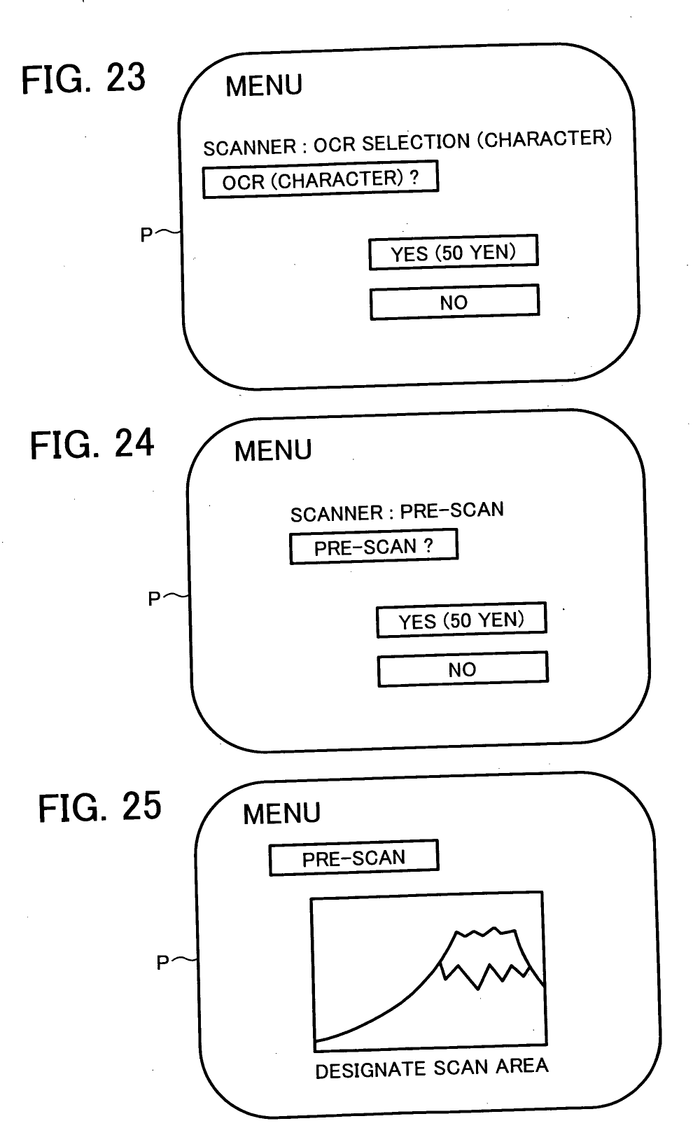

When a user wants to conduct an OCR (optical character recognition) process on the scanned image, a user can select the OCR process from a tenth menu screen shown in FIG. 23. The OCR process can be conducted by an OCR program which can be included in the above-mentioned application program.

In Step S109, a user can select a pre-scanning for a document image scanned by the image scanner 8 from an eleventh menu screen shown in FIG. 14. The pre-scanning is explained below in more detail.

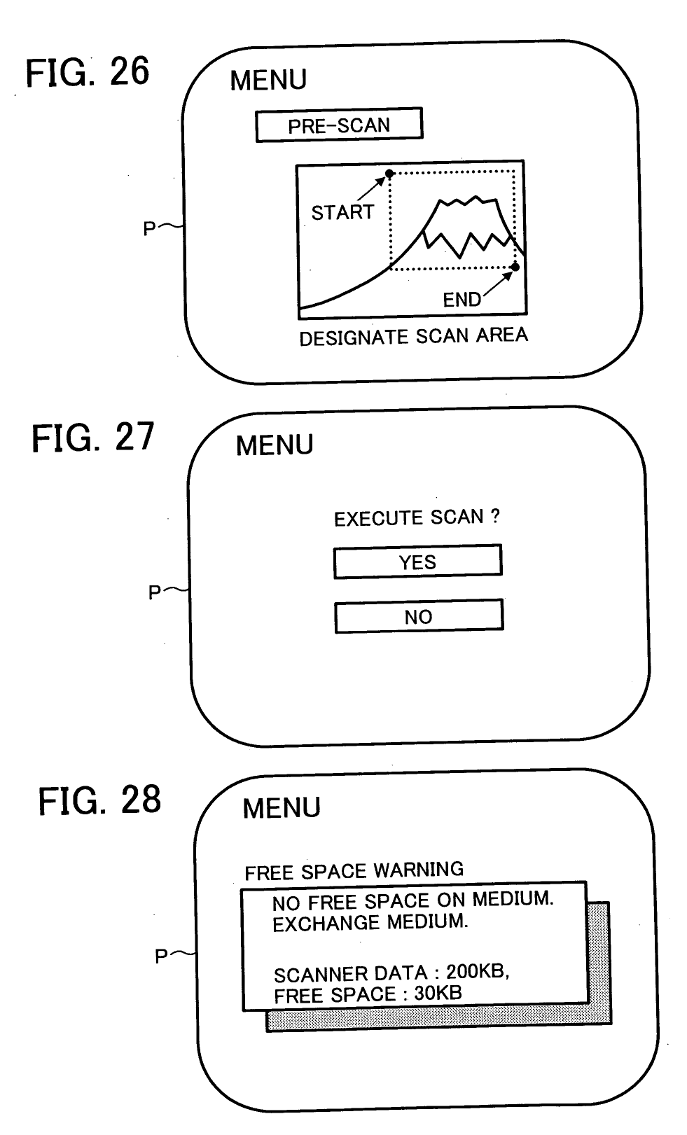

When a user selects the pre-scanning in Step S110, a pre-scanning image is displayed on the operation panel P as a twelfth menu screen shown in FIG. 15 in Step S111. In Step S112, a user can select an area to be scanned from a thirteenth menu screen shown in FIG. 26. Specifically, a user can designate two points (i.e., start and end points) in the pre-scanning image displayed on the operation panel P. Then, in Step 113, a user can select an icon for scanning from a fourteenth menu screen shown in FIG. 27 to execute the scanning at the image scanner 8. If a user does not select a pre-scanning in Step 109, the process goes to Step S113 directly to execute the scanning at the image scanner 8.

In Step S114, the CPU 31 judges whether the free space of the storage medium M selected by a user is sufficient to store image data scanned by the image scanner 8. If the CPU 31 judges that the free space of the storage medium M is not sufficient to store the scanned image data, the operation panel P displays a fifteenth menu screen shown in FIG. 28 as a warning, and the process goes back to Step S106. However, if the CPU 31 judges that the free space of the storage medium M is sufficient to store the scanned image data, the process goes to Step S115.

Hereinafter, the above-mentioned pre-scanning process is described in greater detail. As for the scanning process, a pre-scanning function is highly desired to determine a scanning area when scanning a document image with a terminal apparatus such as personal computer.

When a scanning is conducted for document image by applying a maximum performance level (e.g., higher resolution level) of the image scanner 8 of the image forming apparatus 1, a large-sized scanned image data may be generated.

However, the image forming apparatus 1 may require a longer time to generate such large-sized scanned image data, thereby causing a delay. In addition, such large-sized scanned image may require special devices to display the scanned image on the operation panel P, which is not favorable from the viewpoint of cost.

On one hand, a pre-scanning conducts a scanning of document image with a lower resolution level to reduce a time required to generate and display the scanned image data. From such scanned image data, a user can select an area to be scanned with a higher resolution level. With such multi-step (e.g., two-step in the above case) scanning process, a total scanning time and a total scanned image data size can be reduced, thereby a user-friendly operation can be provided.

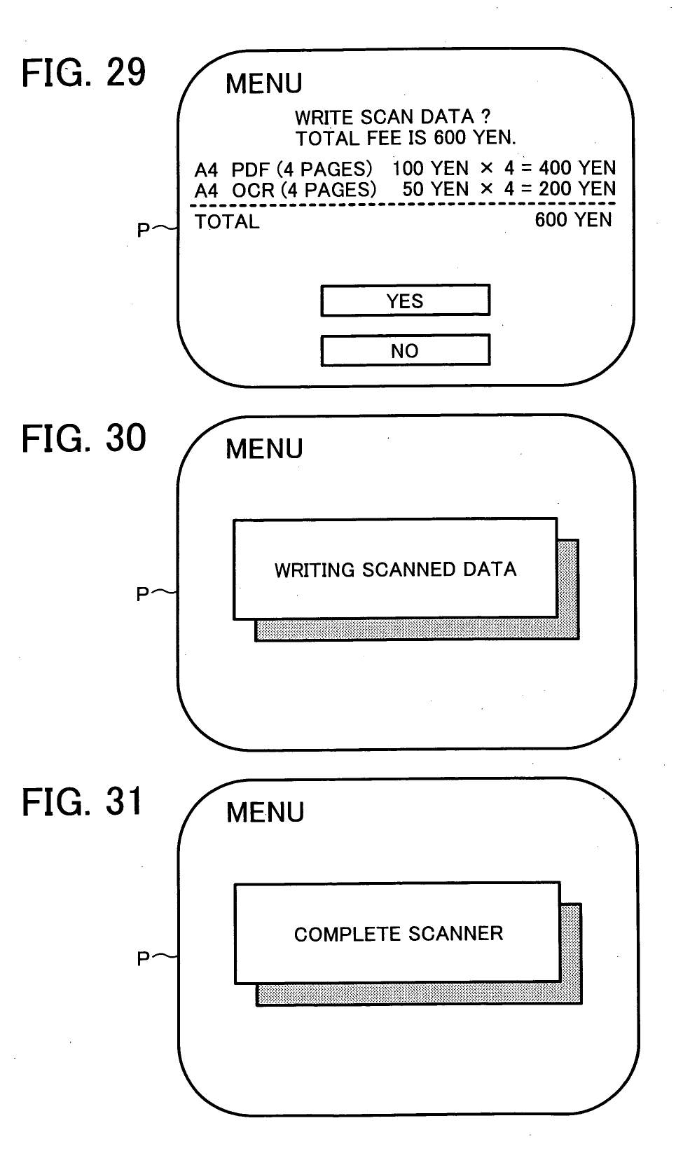

If a user wants to continue a further scanning in Step S115, the process goes back to Step S106. Specifically, a user may continue a further scanning when the user wants to scan a plurality of sheets, for example. If the document scanning is completed in Step S115, the process goes to Step S116 to calculate a fee for scanner service, and the operation panel P displays a sixteenth menu screen shown in FIG. 29.

The fee calculation can be conducted by referring to a look-up table including process conditions, such as color or monochrome of the image, resolution level, image data format, document size, number of papers, pre-scanning or not, and the like.

In Step S117, the CPU 31 judges whether a money balance is enough for charging a fee for scan service. If the CPU 31 judges that a money balance is enough for charging a fee for scan service, the process goes to Step S119.

If the CPU 31 judges that a money balance is not enough for charging a fee for scan service, a user is instructed to insert coins, which are enough for the displayed fee, in the coin vendor 60 in Step S118. When the CPU 31 confirms such insertion, the process goes to Step S119, during which the scanned image data is written to the storage medium selected by a user. A seventeenth menu screen is then displayed on the operation panel P as shown in FIG. 30 indicating that a writing process is in session.

Then, in Step S120, a predetermined key (not shown) is pushed to verify the scanner service. In Step S121, a fee for the scanner service is withdrawn from the coin vendor 60, and a eighteenth menu screen shown in FIG. 31 is displayed on the operation panel P. Then, the process goes back to Step S101.

In the above-described scanning process, the image data scanned by the image scanner 8 is temporarily stored in the SDRAM 14, and later stored in the memory unit 32 or the storage unit 34 in the information processing section B via the hub 19. In the above-mentioned exemplary embodiment, the image data scanned by the image scanner 8 is stored in a predetermined storage medium. However, such scanned image data can be transmitted to a predetermined address by using e-mail, in which the scanned image data may be attached to the e-mail.

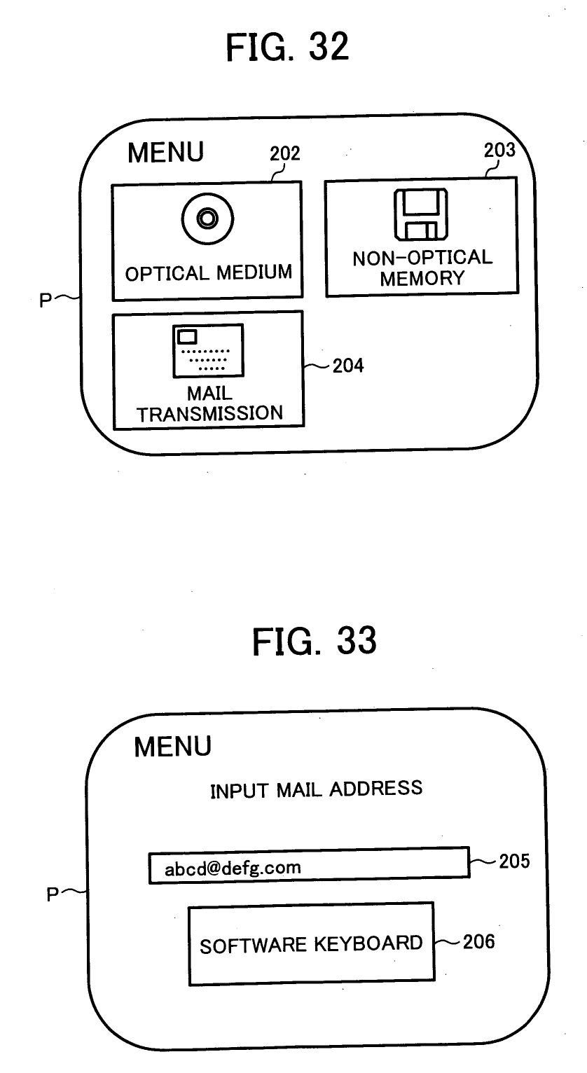

In such a case, the operation panel P displays a nineteenth menu screen shown in FIG. 32 instead of the second menu screen shown in FIG. 15.

A user can select a “mail transmission 204” to transmit the image data with an e-mail. When a user selects the “mail transmission 204,” the operation panel P displays a twentieth menu screen shown in FIG. 33, and a user inputs a mail address in an input section 205.

A user can input the mail address from a software keyboard 206 displayed on the operation panel P with the input section 205.

Furthermore, the image data scanned by the image scanner 8 can be uploaded to the image forming apparatus 1 or an external server connected to the Internet. In such a case, a user can select a unit to be uploaded with the image data, then the user can download such image data from the Internet at his home or the like.

Furthermore, instead of the above-mentioned storage medium, image data scanned by the image scanner can be transmitted to an external device having a memory with a transmission method using a radio wave or infrared light, or the like. Such external device may be cellular phone or the like. In such a case, the information processing section B is required to include a predetermined transmission method using a radio wave or infrared light, or the like. As such, in the above-mentioned example embodiment, the image forming apparatus 1 can generate predetermined image data from the image data scanned by the image scanner 8.

Such predetermined image data can be generated by selecting a data format in Step S108, or by selecting an OCR process for the image data and can be transmitted to a predetermined receiver (e.g., a storage medium, mail address, server).

The coin vendor 60, functioning as charging unit, can conduct a charging process for such document scanning process and data generation and transmission.

With such configurations, the image forming apparatus 1 can be used favorably by a user who wants to obtain image data scanned in a higher quality (e.g., higher resolution level).

Furthermore, the image forming apparatus 1 can selectively conduct the pre-scanning when scanning the document image by the image scanner 8, and can transmit the scanned image data. Such image data can be transmitted to a predetermined receiver (e.g., a storage medium, mail address, server).

The coin vendor 60, functioning as charging unit, can conduct a charging process for such document scanning process and data generation and transmission.

With such configurations, the image forming apparatus 1 can be used favorably by a user who wants to obtain image data scanned in a higher quality (e.g., higher resolution level).

The above-described disclosure may be conveniently implemented using a conventional general purpose digital computer programmed according to the teaching of the present specification, as will be apparent to those skilled in art in the computer art. Appropriate software coding can readily be prepared by skilled programmers based on the teaching of the present disclosure, as will be apparent to those skilled in art in the software art. The present invention may also be implemented by the preparation of the application specific integrated circuits or by interconnecting an appropriate network of conventional component circuits, as will be apparent to those skilled in the art.

Numerous additional modifications and variations are possible in light of the above teachings. It is therefore to be understood that within the scope of the appended claims, the disclosure of the present invention may be practiced otherwise than as specifically described herein.

This application claims priority from Japanese patent applications No. 2004-226746 filed on Aug. 3, 2004, and No. 2004-268550 filed on Sep. 15, 2004 in the Japan Patent Office, the entire contents of which are hereby incorporated by reference herein.

What is claimed is:

1. An image processing system connected to a communication network, comprising:
an information processing unit;
an image processing unit connected to the information processing unit and configured to conduct image processing selected by a user to obtain image data;
a transmitter configured to transmit the image data to an external receiver; and
a charging unit connected to and controlled by the information processing unit and configured to charge a fee corresponding to the image processing selected by the user before the image data is transmitted to the external receiver.

2. The image processing system according to claim 1, wherein the information processing unit comprises:
a storage medium configured to store programs including a general purpose operating system and an application program which control the image processing system.

3. The image processing system according to claim 2, wherein:
the application program includes a charging control module program configured to control the charging unit.

4. The image processing system according to claim 2, wherein:
the program is downloaded to the storage medium from the communication network.

5. The image processing system according to claim 1, wherein:
the transmitter is configured to transmit the image data to the external receiver via the communication network.

6. The image processing system according to claim 5, wherein:
the communication network comprises at least one of an Internet and public switched telephone network.

7. The image processing system according to claim 1, wherein:
the transmitter is configured to transmit the image data to the external receiver directly from the image processing system.

8. The image processing system according to claim 1, wherein the image processing unit comprises:
a plurality of functions selectable by a user of the image processing system.

9. An image processing system connected to a communication network, comprising:
means for processing information;
means for conducing image processing selected by a user to obtain image data, connected to the means for processing information;
means for transmitting the image data to an external receiver; and
means for charging a fee corresponding to the image processing selected by the user before the image data is transmitted to the external receiving means, wherein the means for charging a fee is connected to the information processing means and controlled by the means for processing information.

10. A method of charging a fee corresponding to image processing provided by an image processing system, the method comprising:
reading a document image to obtain image data;
selecting image processing to be conducted on the image data;
conducting the image processing on the image data;
determining a fee corresponding to the image processing selected by the user;
charging the fee; and
transmitting the image data to an external receiver after charging.

11. The method according to claim 10, wherein:
the image processing is performed based on the selection of one of a plurality of functions selectable by the user.

12. A program comprising computer-readable instructions that, when executed by a computer of an information processing unit of an image processing system, instruct the image processing system to carry out a method of image processing having a plurality of functions to obtain image data, and calculate and charge a fee matching to image processing selected by a user, the computer-readable instructions, when executed performing operations comprising:
reading a document image to obtain image data;
selecting image processing to be conducted on the image data;
conducting the image processing on the image data;
determining a fee matching to the image processing selected by the user;
charging the fee; and
transmitting the image data to an external receiver after charging.

13. The program according to claim 12, further comprising:
a charging control module program configured to control the charging.

14. An image processing system connected to a communication network, comprising:
an information processing unit;
an image processing unit connected to the information processing unit and configured to conduct image processing to obtain image data; and
a charging unit connected to and controlled by the information processing unit and configured to charge a fee corresponding to the image processing selected by a user before the image data is transmitted to an external receiver.

15. The image processing system according to claim 14, wherein the information processing unit comprises:
a storage medium configured to store programs including a general purpose operating system and an application program which control the image processing system.

16. The image processing system according to claim 15, wherein:
the application program includes a charging control module program which controls the charging unit.

17. The image processing system according to claim 14, wherein:
the image processing unit is configured to convert a data format of the image data.

18. The image processing system according to claim 14, wherein:
the image processing unit is configured to conduct an optical character recognition to the image data.

19. The image processing system according to claim 14, further comprising:
a transmitter configured to transmit the image data to the external receiver.

20. The image processing system according to claim 19, wherein:
the transmitter is configured to transmit the image data to an electronic mail address by attaching the image data to an electronic mail via the communication network.

21. The image processing system according to claim 19, wherein:
the transmitter is configured to transmit the image data to a server via the communication network.

22. The image processing system according to claim 19, wherein:
the transmitter is configured to transmit the image data to the external receiver directly from the image processing system.

23. The image processing system according to claim 14, wherein:
the image processing system conducts an image scanning operation using the image processing unit and the information processing unit to obtain scanned image data and transmit the scanned image data to the external receiver.

24. The image processing system according to claim 14, wherein:
the image processing system conducts a first image scanning operation to obtain a first scanned image data and sequentially conducts a second image scanning operation to obtain a second scanned image data based on the first scanned image data, and transmits the second scanned image data to the external receiver, wherein the first image scanning is conducted with a first resolution level, and the second scanning is conducted with a second image resolution level, in which the first resolution level is lower than the second resolution level.

25. A program comprising computer-readable instructions that, when executed by a computer of an information processing unit of an image processing system, instruct the image processing system to carry out a method of image scanning to obtain scanned image data, and calculate and charge a fee matching to the image scanning selected by a user, the computer-readable instructions, when executed performing operations comprising:
scanning a document image to obtain scanned image data;
selecting an image processing to be conducted on the scanned image data;
conducting the image processing on the image data;
determining a fee corresponding to the image processing selected by the user;
charging the fee; and
transmitting the image data to an external receiver after the charging.

26. The program according to claim 25, further comprising:
converting a data format of the scanned image data.

27. The program according to claim 25, further comprising:
performing optical character recognition to the scanned image data.

28. The program according to claim 25, wherein:
the image processing system comprises a transmitter configured to transmit the scanned image data to the external receiver.

29. The program according to claim 28, further comprising:
transmitting the scanned image data to an electronic mail address by attaching the scanned image data to an electronic mail via the communication network.

30. The program according to claim 28, further comprising:
transmitting the scanned image data to a server via the communication network.

31. The program according to claim 28, further comprising:
transmitting the image data to the external receiver directly from the image processing system.

32. A program comprising computer-readable instructions that, when executed by a computer of an information processing unit of an image processing system, instruct the image processing system to carry out a method of multi-step image scanning to obtain scanned image data, and calculate and charge a fee matching to the multi-step image scanning selected by a user, the computer-readable instructions, when executed performing operations comprising:
firstly scanning a document image with a first resolution level to obtain a first scanned image data;
selecting an image area from the first scanned image data for a further scanning;
secondary scanning the selected image area with a second resolution level to obtain a second scanned image data, in which the second resolution level is higher than the first resolution level;
determining a fee corresponding to the multi-step image scanning selected by the user;
charging the fee; and
transmitting the second scanned image data to a external receiver.
